(19) United States
(12) Patent Application Publication
(10) Pub. No.: US 2007/0076107 A1
(43) Pub. Date: Apr. 5, 2007

(54) Digital camera for producing a frame of image formed by two areas with its seam compensated for

(75) Inventor: Tomoyuki Nishimura, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/528,574

(22) Filed: Sep. 28, 2006

(30) Foreign Application Priority Data
Sep. 30, 2005 (JP) 2005-286905

(51) Int. Cl. H04N 3/14; H04N 5/335

(52) U.S. Cl. 348/294

(57) ABSTRACT

A digital camera includes an accumulator for accumulating, out of digital image signals representative of respective divided images, adjoining pixel data positioned at both sides of a seam between the divided images. The digital camera also includes a controller for calculating difference in characteristic between the divided images on the basis of sums output from the accumulator; and a signal processor for correcting the pixel data in accordance with the difference output from the controller, thereby correcting the seam.

### BACKGROUND OF THE INVENTION

1. Field of the Invention

The present invention relates to a digital camera and more particularly to a digital camera including a solid-state image sensor having a image sensing or photosensitive surface divided into a plurality of areas.

2. Description of the Background Art

It is a common practice with a digital camera to use a solid-state image sensor including a great number of photosensors or photodiodes that generate signal charges in response to incident light. The signal charges are then read out as an electric signal to be processed to produce image data. Today, a digital camera can produce not only still picture but also moving pictures and high-resolution picture, so that it is necessary to read out the signal charges from the image sensor in a short period of time. For this purpose, the image sensing surface or an array of photosensitive cells in the image sensor is usually divided into a plurality of areas so as to read out the electric signals in parallel from the areas.

However, some of the problems with multiple-area type image sensor are that the electric signals read out of the areas in parallel are different in characteristic from area to area. Consequently, image data derived from such signal include pixel data different in tint, lightness and so forth from area to area, i.e. the pixel data with irregularities between the areas.

More specifically, in order to produce an electric signal from the image sensor, the conversion of signal charges generated in the photodiodes to an electric signal is executed by an output circuit also included in the image sensor. It follows that when the image sensing surface is divided into a plurality of areas, the areas are provided with a respective output circuit each. However, the characteristics of circuit elements and the gain of an amplifier included in the output circuits are different from circuit to circuit, so that electric signals output from the image sensor area by area are different in black level, gain and so forth, i.e. in the characteristics of the electric signal. The resulting digital image data include pixel data different from each other area by area.

Japanese patent laid-open publication No. 2002-77729, for example, discloses a solid-state image pickup apparatus configured to form smooth image having no boundary between the areas of the image sensing surface by reducing differences between image data ascribable to the different areas. The apparatus must, however, emit uniform light on its solid-state image sensor before picking up a desired subject or scene in order to calculate differences between areas with the resulting electric signals to thereby compensate for the differences between those areas. The apparatus therefore needs an extra device for emitting uniform light and is costly and large-size. Further, the interval increases between consecutive shots because pickup must be repeated twice, including one with the uniform light, for a single image.

### SUMMARY OF THE INVENTION

It is an object of the present invention to provide a digital camera capable of forming image data causing no boundary seam in the image, without increasing cost or the size of its solid-state image sensor.

A digital camera of the present invention includes a solid-state image sensor including an image sensing surface divided into a plurality of areas and producing a plurality of analog electric signal streams. An analog signal processor executes analog signal processing on the plurality of analog electric signal streams and converts resulting processed analog electric signals to a corresponding plurality of digital imag$e signals. A digital signal processor executes digital signal processing on each of the plurality of digital image signals to thereby produce a single frame of image. An accumulator accumulates the pixel data corresponding to a portion that forms a seam between the plurality of areas. A calculator calculates the difference in characteristic between the plurality of areas on the basis of sums output from the accumulator. A corrector corrects the pixel data in accordance with the difference output from the calculator.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a digital camera in accordance with the present invention;

FIG. 2 is a front view schematically showing the image sensing surface of an image sensor included in the illustrative embodiment shown in FIG. 1;

FIG. 3 is a flowchart useful for understanding a specific procedure executed by the illustrative embodiment;

FIG. 4 is a schematic front view for use in describing a specific image picked up;

FIG. 5 is a fragmentary enlarged view schematically showing part of a seam portion included in the image of FIG. 4;

FIG. 6 is a graph plotting specific values calculated in the illustrative embodiment;

FIG. 7 is a flowchart useful for understanding another specific procedure executed by the illustrative embodiment;

FIG. 8 is a front view, like FIG. 4, useful for understanding the procedure of FIG. 7;

FIG. 9 is a flowchart useful for understanding another specific procedure to be executed by the illustrative embodiment;

FIG. 10 is a front view, like FIG. 4, useful for understanding the procedure of FIG. 9;

FIG. 11 is a flowchart useful for understanding another specific procedure to be executed by the illustrative embodiment; and

FIG. 12 is a schematic front view for use in describing a specific image used with the procedure of FIG. 11.

### DESCRIPTION OF THE PREFERRED EMBODIMENT

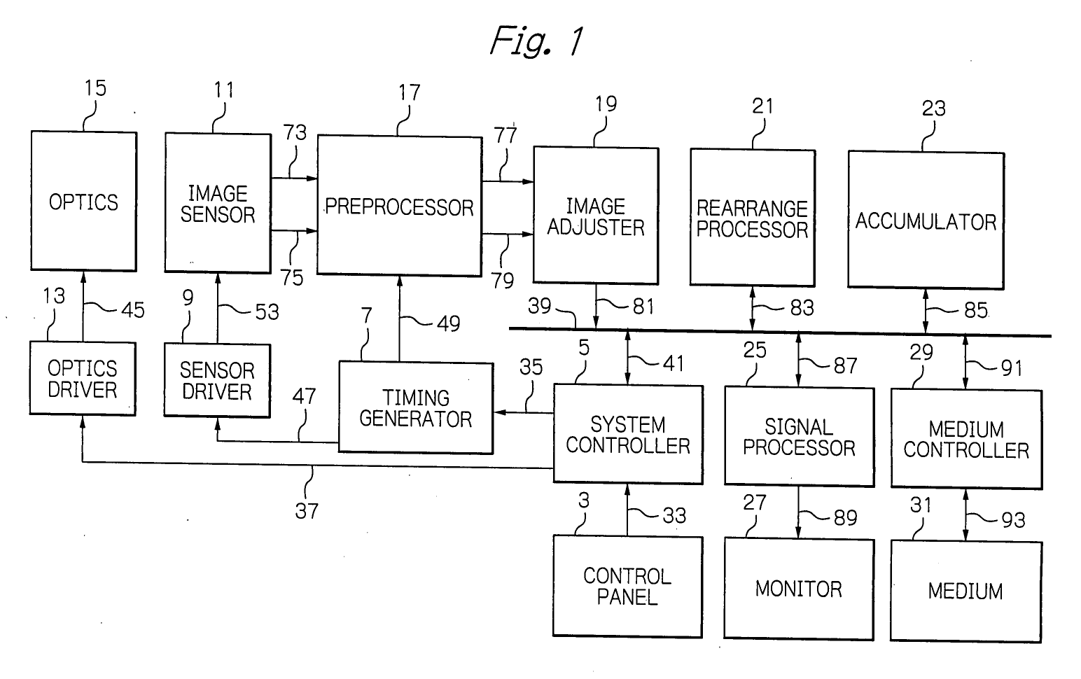

Referring to FIG. 1 of the accompanying drawings, a digital camera embodying the present invention, generally 1, includes an image pickup sensor 19 for picking up a desired scene to produce image data representative of the scene. As shown, the digital camera 1 generally includes a control panel 3, a system or main controller 5, a timing generator 7, a sensor driver 9, an image sensor 11, an optics driver 13, optics 15, a preprocessor 17, an image adjuster 19, a rearrange processor 21, an accumulator 23, a signal processor 25, a picture monitor 27, a medium controller 29 and a medium 31 which are interconnected as illustrated to form digital image data in response to light representative of a field picked up.

Briefly, the digital camera 1 is imaging apparatus for receiving light by the optics 15 incident from a field to be imaged, and being operative in response to the manipulation of the control panel 3 to cause the image sensor 11 to pick up the field under the control of the system controller 5, optics driver 13 and sensor driver 9 to produce an analog electric signal representative of the image of the field, the analog electric signal being sequentially processed by the preprocessor 17 and image adjuster 19 into digital image data, which are processed by the rearrange processor 21, accumulator 23 and signal processor 25 and then displayed on the picture monitor 27 or written to the recording medium 31 via the medium controller 29.

In FIG. 1, part of the circuitry not directly relevant to the understanding of the present invention is not shown, and detailed description thereof will not be made in order to avoid redundancy. Signals are designated with reference numerals designating connections on which the signals appear.

The control panel 3 is a manipulatable device operated by the operator for inputting desired commands. More specifically, the control panel 3 sends an operation signal 33 to system controller 5 in response to the operator's operation, e.g. the stroke of a shutter release button, not shown, depressed by the operator. The system controller 5 is a general controller adapted to control the operation of the entire digital camera 1 in response to, e.g. the operation signal 33 received from the control panel 3. In illustrative embodiment, the controller controls the optics system driver 13 and timing generator 7 with the control signals 35 and 37, respectively. The system controller 5 also controls the image adjuster 19, rearrange processor 21, accumulator 23, signal processor 25 and medium controller 29 with the control signal 41 delivered over a data bus 39 for causing them to execute necessary processing.

The optics driver 13 includes a drive circuit, not shown, for generating a drive signal 45 for driving the optics 15 in response to the control signal 37. The optics 15 include a lens system, an iris diaphragm control mechanism, a shutter mechanism, a zoom mechanism, an automatic focus (AF) control mechanism and an automatic exposure (AE) control mechanism, although not shown specifically. The optics 15 may additionally include an infrared ray (IR) cut filter and an optical low-pass filter (LPF), if desired. In the illustrative embodiment, the lens system, and the AF and AE control mechanisms are driven by the drive signal 45 to input the optical image of a desired field to the image sensor 11.

The timing generator 7 includes an oscillator, not shown, for generating a system or basic clock, for the timing operation of the entire digital camera 1, and may be adapted to deliver the system clock to various blocks or subsections of the circuitry, although not shown in FIG. 1 specifically. In the illustrative embodiment, the timing generator 16 generates timing signals 47 and 49 in response to the control signal 35 fed from the system controller 5 and feeds the timing signals 47 and 49 to the sensor driver 9 and preprocessor 17, respectively.

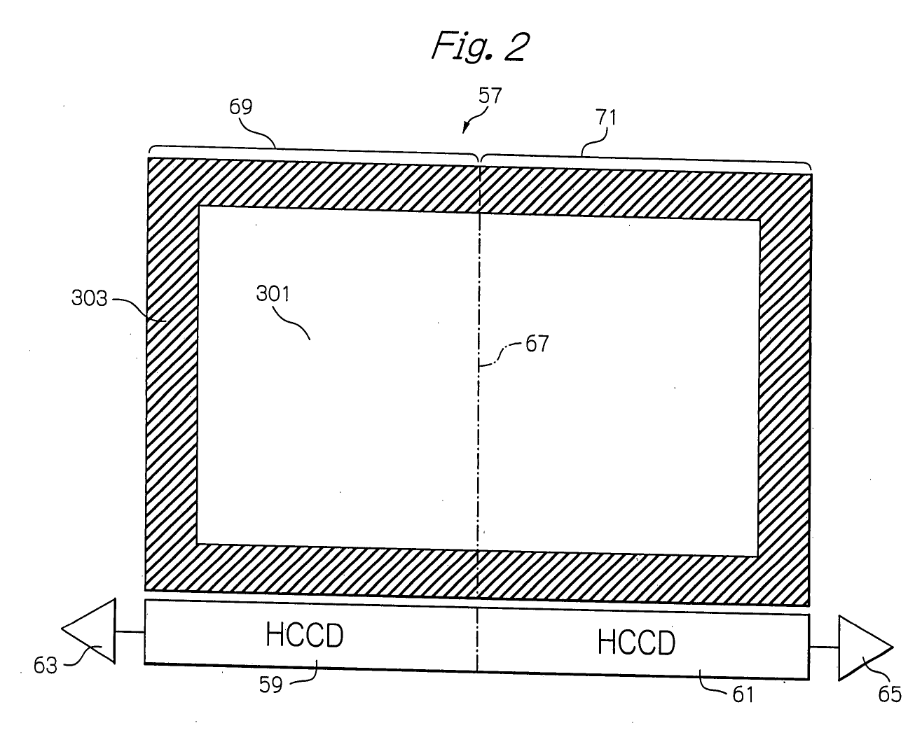

The sensor driver 9 serves as driving the image sensor 11. In the illustrative embodiment, the sensor driver 9 generates a drive signal 53 in response to the timing signal 47 fed from the timing generator 7 and feeds the drive signal 53 to the image sensor 11. The image sensor 11 is adapted to convert the optical image of a field to corresponding analog electric signals 73 and 75, FIG. 1, and has an image sensing surface or photosensitive array 57, see FIG. 2, for producing electric charges representing a single frame of image. In the illustrative embodiment, the image sensor 11 is implemented by a charge-coupled device (CCD) image sensor by way of example.

FIG. 2 is a front view schematically showing the image sensing surface 57 of the image sensor 11 included in the illustrative embodiment. In the image sensing surface 57, there are a great number of photodiodes or photosensors arranged in a bidimensional matrix, transfer gates arranged to control the read-out of signal charges generated in the photodiodes and vertical transfer paths arranged to transfer the signal charges read out of the photodiodes in the vertical direction, which are not specifically shown. In the image sensing surface 57, there are also horizontal transfer paths, labeled HCCDs in FIG. 2, 59 and 61 arranged to transfer the signal charges input from the vertical transfer paths in the horizontal direction and output sections 63 and 65 arranged to be connected to the ends of the horizontal transfer paths 59 and 61, respectively. The image sensor 11 may additionally have a color filter, although not shown specifically.

The photodiodes, transfer gates, vertical transfer paths, horizontal transfer paths 59 and 61 and output sections 63 and 65 may be conventional and will not be described specifically. Also, for the color filter, any conventional color filter may be used.

As shown in FIG. 2, the image sensing surface 57 has non-effective area 301 located all around the surface, and an effective area 303 located to be surrounded by the non-effective area 301. The non-effective area, i.e. the optical black (OB) zone, 301 is formed by optically shielding the photodiodes or photosensors of the image sensor 11. In the illustrative embodiment, the camera 1 is adapted to produce an image on the basis of signal charges generated in the effective area 303 while sensing black level and calculating a correction value for correcting the image on the basis of the result of the transfer of signal charges available in the non-effective area 301. The image sensor 11 of the illustrative embodiment has its focus and exposure controlled such that light input via the lens of the optics 15 is incident not only the effective area 303 but also on the non-effective area 301, thus forming an image circle.

In the illustrative embodiment, the imaging surface 57 is divided into a plurality of areas, which generate a corresponding plurality streams of divided image data. As shown in FIG. 2, the image sensing surface 57 is divided into two areas, by way of example, i.e. a first area 69 and a second area 71, which are adjoining each other and are arranged at opposite sides of the central line 67 thereof. The first and second areas 69 and 71 include horizontal transfer paths, HCCDs, 59 and 61 and output sections 63 and 65 respectively so that image sensor 11 outputs two analog electric signals 73 and 75 at the same time by parallel photoelectric conversion.

While the image sensing surface 57 is divided into two areas in the illustrative embodiment, it may be divided into three or more areas in matching relation to a digital camera, if desired. In any case, a single horizontal transfer path and a single output circuit are assigned to each divided area.

Referring again to FIG. 1, the analog electric signals 73 and 75 are fed to the preprocessor 17 from the image sensor 11. The preprocessor 17 includes various circuits, e.g. the correlated-double sampling (CDS) circuit, a gain-controlled amplifier (GCA) and the analog-to-digital (AD) converter. The CDS circuit, gain-controlled amplifier, the AD converter and so forth, controlled by the timing control signal 49, execute analog processing on the analog electric signals 73 and 75 for thereby outputting the resulting digital signals 77 and 79, respectively.

The image adjuster 19 is adapted to produce a single stream of output data, i.e. digital image data 81 from the two input signals 77 and 79. In the illustrative embodiment, the image adjuster 19 samples the signals 77 and 79 with a frequency twice as high as the frequency of the signals 77 and 79 to thereby produce the digital image data 81. The image adjuster 19 may write the digital image data 81 in a memory not shown, if desired. The image data 81 are fed from the image adjuster 19 to the rearrange processor 21 over the data bus 39.

The rearrange processor 21 is adapted to rearrange, i.e. combines the pixel data included in the digital image data 81 so as to complete a single image. In the illustrative embodiment, the rearrange processor 21 rearranges the pixel data of the digital image data 81 in the sequence of the dots on a scanning line for thereby producing digital image data 83 representative of a single complete picture. Such image data 83 are delivered to the accumulator 23 over the data bus 39.

The accumulator 23 is adapted to sum, i.e. accumulate, among the pixel data included in the input image data 83, pixel data adjoining a central line or seam between the divided areas area by area to thereby output the resulting sums 85. More specifically, in the illustrative embodiment, the accumulator 23 accumulates pixel data of pixels adjoining the central line or seam 67 between the two areas 69 and 71, FIG. 2, area by area. Such integration or accumulation is necessary in the illustrative embodiment because the image sensing surface 57 is divided into two.

More specifically, the digital image data 83 consists of two streams of image data derived from the analog electric signals 73 and 75 transduced with the output section 63 and 65 respectively. The output section 63 and 65 may however be different in characteristic from each other so that the electric signals 73 and 75 may be different in tint, lightness and so forth when the digital image data 83 are displayed. Consequently, tint and lightness may be different between the right and left portions of a display screen when the digital image data 83 are displayed.

In light of the above, in the illustrative embodiment, the accumulator 23 functions as accumulating pixel data of the pixels corresponding to the border or seam portion 67 where the two areas 69 and 71 join each other area by area to thereby produce values 85 representative of the degree of differences in tint and lightness between the areas 69 and 71. Correction is then executed on the basis of such values calculated.

The sums 85 then are fed to the system controller 5 over the data bus 39 in order to be used for calculating differences between the two areas 69 and 71. The controller calculates the differences and then commands the preprocessor 17 or signal processor 25 to correct the gain or the luminance of the image data for thereby canceling the differences.

The signal processor 25 is adapted to process the digital image data 83 in response to the control signal 41 input from the system controller 5. In the illustrative embodiment, the signal processor 25 corrects the gain, the luminance or the tint of particular pixel data forming part of the digital image data 83 to thereby output digital image data 87 in which the seam between the first and second areas 69 and 71 is not conspicuous. Also, the signal processor 25 feeds the corrected digital image data 87 to the monitor 27 as image data 89 while feeding the same image data 87 to the medium controller 29 as data 91.

The medium controller 29 is adapted to generate a drive signal 93 for recording the input data 91 in the recording medium 31 in response to the control signal fed from the system controller 5. Thus, the data 91 are recorded in the recording medium 31, which may be implemented as a memory by way of example.

The configuration of the digital camera 1 described above is similarly applicable to, e.g. an electronic still camera, an image inputting device, a movie camera, a cellular phone with a camera or a device for shooting a desired object and printing it on a seal so long as it includes an image sensor and generates digital image data representative of a field picked up. Of course, the individual structural parts and elements of the digital camera 1 are only illustrative and may be changed or modified, as desired.

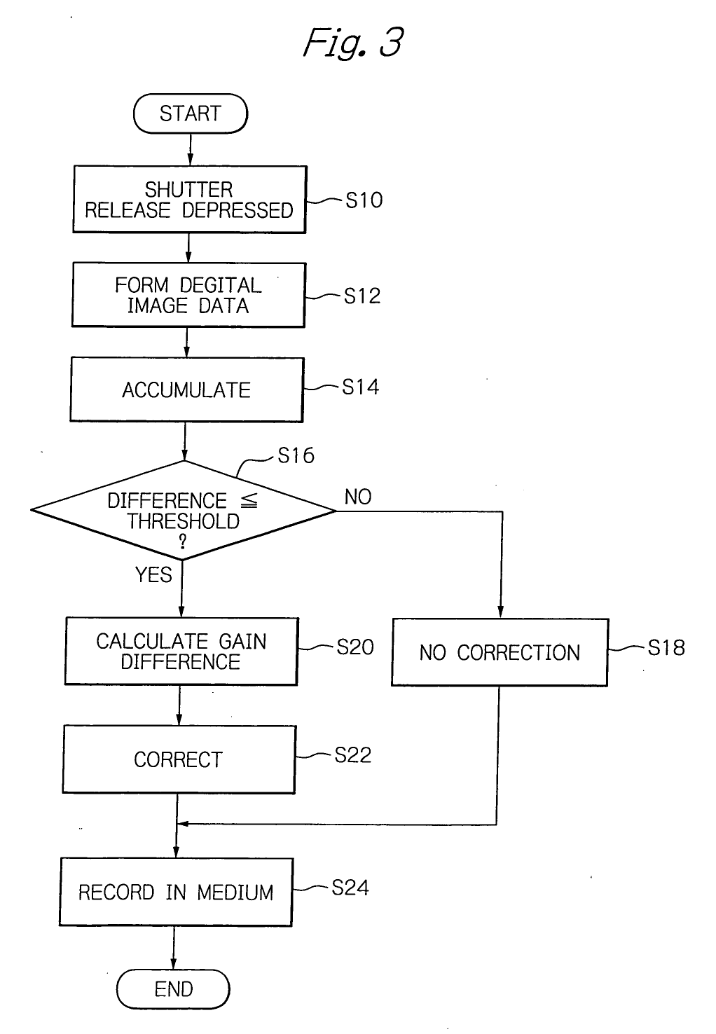

FIG. 3 is a flowchart demonstrating a specific procedure available with the illustrative embodiment for correcting the pixel data. The procedure that will be described with reference to FIG. 3 is executed in a pickup mode where digital image data representative of a field picked up are written to the recording medium 31. As shown, when the operator depresses the shutter release button on the control panel 3, the control panel 3 delivers a drive signal 33 indicative of the pickup mode to the system controller 5 (step S10). In response, the image sensor 11, the preprocessor 17, image adjuster 19 and rearrange processor 21 execute processing under the control of the system controller 5 so as to form digital image data 83. The digital image data 83 are input to the accumulator 23 (step S12).

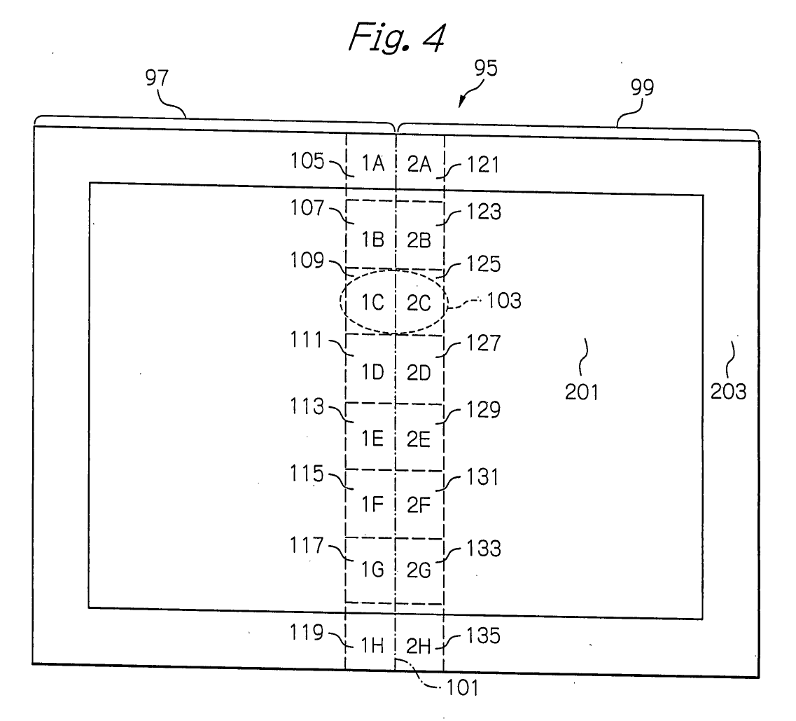

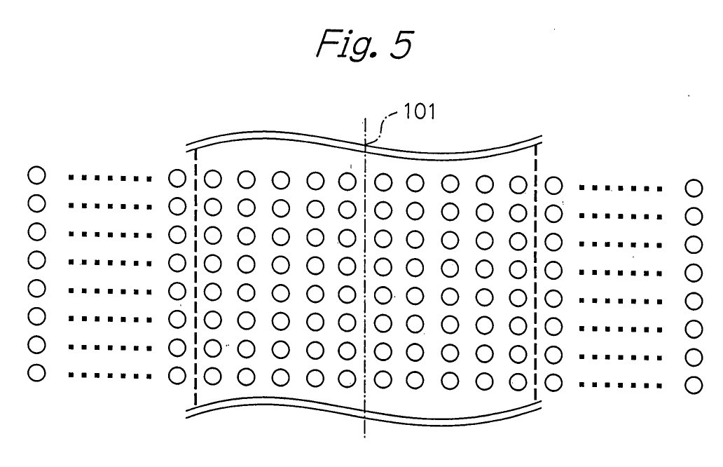

The accumulator 23 then accumulates, among pixel data derived from the first and second areas 69 and 71, FIG. 2, pixel data adjoining the central line or seam 67 between the areas 69 and 71 area by area (step S14). More specifically, as shown in FIGS. 4 and 5, the accumulator 23 accumulates the first to fifth pixel data lying in segments 105 through 135, segment by segment.

FIG. 4 shows schematically specific image 95 formed by the digital image data 83 fed to the accumulator 23 from the rearrange processor 21. FIG. 5 is a fragmentary enlarged view showing schematically a portion of the image 95, e.g. a portion indicated by a circle 103 in FIG. 4, where pixels formed by the image data output from the first areas 69 and 71 adjoin each other at opposite sides of the central line 101. In FIG. 5, constituents like those shown in FIG. 4 are designated by identical reference numerals, and will not be described specifically again in order to avoid redundancy.

As shown in FIG. 4, when the digital image data 83 are output from the rearrange processor 21, a single image 95 is formed by a first image area 97 consisting of the pixel data derived from the analog electric signal read out of the first area 69 of the image sensing surface 57 and a second area 99 consisting of the pixel data derived from the analog electric signal read out of the second area 71 of the same. The first and second image areas 97 and 99 adjoin each other at the left and the right, respectively, of the central line or seam 101 of the image 95.

The image 95 is also made up of an effective area 201 and an OB zone 203 surrounding the effective area 201 for sensing black levels. The effective area 201 and OB zone 203 correspond to the effective area 303 and the non-effective area 301, respectively, in the image sensing surface 57.

The first and second image areas 97 and 99 are different in, e.g., tint and lightness from each other due to the differences in characteristic between the output sections 63 and 65 of the first and second areas 69 and 71 stated previously. The accumulator 23 accumulates the pixel data constituting the pixels adjoining the central line 101 in each of image areas 97 and 99.

More specifically, as shown in FIG. 5, the accumulator 23 of the illustrative embodiment accumulates pixel data forming the first to fifth consecutive pixels as counted form the central line 101, adjoining each other in the right-and-left direction in each of the first and second image areas 97 and 99. The accumulator also accumulates not all the first to fifth pixels of pixel data but some pixels of pixel data at a time, which are lying in a segment. More specifically, in the illustrative embodiment the accumulator 23 divides the central line or seam 101, e.g. the portion of the first and second image areas 97 and 99 adjoining the central line 101 (seam portions hereinafter) into eight segments in the vertical direction in order to accumulate pixel data segment by segment.

FIG. 4 shows the above segmentation more specifically. As shown, the seam portion of the first image area 97 adjoining the seam 101 is divided into a 1A segment 105, a 1B segment 107, a 1C segment 109, a 1D segment 111, a 1E segment 113, a 1F segment 115, a 1G segment 117 and a 1H segment 119, as named from the top toward the bottom. Likewise the seam portion of the second image area 99 adjoining the seam 101 is divided into segments a 2A segment 121, a 2B segment 123, a 2C segment 125, a 2D segment 127, a 2E segment 129, a 2F segment 131, a 2G segment 133 and a 2H segment 135. The segments 105 through 119 and segments 121 through 135 adjoin each other at opposite sides of the seam 101, respectively.

Of course, the number of pixel data to be integrated or accumulated together shown and described is only illustrative and may be replaced with any other suitable number of pixels. Also, the portion of each image area may be divided into any desired number of segments or may not be divided at all, as the case may be. A plurality of streams of pixel data should preferably be integrated together at each of the right and left sides of the central line, as shown and described, in order to absorb the errors of the pixel data. Further, the number of pixel data to be integrated and/or the number of segments may be varied in matching relation to the kind of a field to be picked up, which may be a landscape or a person or persons by way of example. By segmenting the seam portion of each image area, as shown and described, it is possible to execute the integration of the pixel data in parallel for thereby saving a period of time necessary for integration.

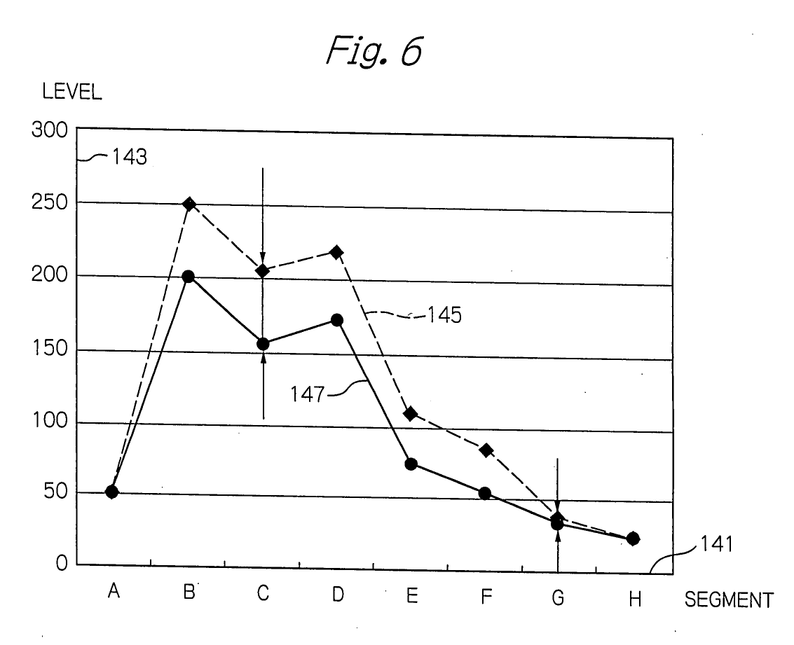

As stated above, the accumulator 23 sums up the pixel levels of the pixel data forming the first to fifth pixels at each side of the central line or seam 101 on an image area and segment basis. FIG. 6 is a graph plotting specific sums produced in the illustrative embodiment. In FIG. 6, the abscissa 141 show the portions A through H, FIG. 4, where pixel data should be integrated while the ordinate 143 show pixel levels, i.e. sums. Also, a dotted line 145 is representative of specific sums of pixel data calculated in the segments 105 through 119 of the first image area 97 while a line 147 is representative of specific sums of pixel data calculated in the segments 121 through 135 of the second image area 99.

Whereas in the illustrative embodiment the sum of the pixel levels of image data in each segment is used as a value with which the difference is calculated, a mean value in each segment may be used, for example, if the levels of the individual pixel data are great and therefore sums calculated in the individual segments are so great, it is then difficult for the e.g. system controller 5 to calculate the difference. 5.

As shown in FIG. 3, the segment-based sums then deriver to the system controller 5 from the accumulator 23. The system controller 5 calculates differences between the sums of the adjoining segments belonging to the first and second image areas 97 and 99 and determines, based on the differences, whether or not the seam is hardly visible between the image data of the first and second image areas 97 and 99 (step S16). For example, the system controller 5 calculates a difference between the sums of the 1A and 2A segments 105 and 121 and determines, based on the difference, whether or not the seam between the segments 105 and 121 is conspicuous, and repeats such a decision with the other segments 107 and 123 through 119 and 135 as well.

When the difference between the sums is smaller than the predetermined value, the seam between the first and second image areas 97 and 99 is conspicuous. This is because when the difference between the sums is great, the image of the field is considered to be of the kind changing in color or lightness at the seam, so that the seam between the two image areas 97 and 99 ascribable to differences in the characteristics of pixel data is considered to be inconspicuous.

For example, as for the lines 145 and 147 shown in FIG. 6, a difference between the 1C segment 109 and the 2C segment 125 is great, so that the difference in characteristic between the pixel data of the 1C segment and the 2C segment is considered to be inconspicuous. Conversely, a difference between the 1G segment 117 and the 2G segment 133 is small, so that the difference in characteristic between the segments 1C and 2C is considered to be conspicuous, rendering the seam between the two image areas 97 and 99 conspicuous. The system controller 5 therefore determines that the 1C segment 109 and 2C segment adjoining each other 125 do not need correction, but the 1G segment 117 and 2G segment 133 need correction.

Note that when, for example, the image has high luminance or when the levels of the image data are great and therefore the resulting sums are great, it should be use a higher or greater value than usual one in order to have the system controller 5 determined correctly.

As shown in FIG. 3, if the difference is greater than the predetermined value (No, step S16), then the system controller 5 determines that the correction is not necessary (step S18). The controller then has the signal processor 25 forming the digital image data 89 and 91 from the non-corrected data 83 in order to have the monitor 27 displaying non-corrected image and the medium 31 recording the non-corrected image data (step S24). The procedure then proceeds to its end as shown in FIG. 3.

On the other hand, if the segments of interest need correction (Yes, step S16), then the system controller 5 produces a correction value on the basis of the difference and/or sum with any suitable method (step S20). For example, the system controller 5 may calculate the difference of gain as the correction value, or may read out the correction value from the storage, not shown, which stores the predetermined correction value corresponding to e.g. the portion of the segment, field and so forth. In the illustrative embodiment, the system controller 5 divides one of the two segment-based sums by the other one in order to calculate the gain difference for using as the correction value and feed the control signal 41 to the signal processor 25 so as to correct the pixel data with the calculated gain difference. Of course, the system controller 5 may alternatively calculate a sensitivity difference and have the signal processor 25 correcting a gain in such a manner as to establish identical sensitivity, if desired.

In response, the signal processor 25 corrects the gain of the digital image data 83 in response to the control signal 41 fed from the system controller 5 (step S22). In the illustrative embodiment, the signal processor 25 corrects the gains of only the pixel data belonging to the segments determined to need correction by the system controller 5. Alternatively, the signal processor 25 may correct the gains of the image data belonging to all the segments or may even selectively correct only part of the image data or all the image data in accordance with differences between the segments produced from the differences or the digital image data.

After the above correction, the signal processor 25 processes the corrected image data in order to display on the display screen in the monitor 27 and produces data 91 capable of being written to the recording medium 31 from the corrected image data. The data 91 are then written to the recording medium 31 under the control of the medium controller 29 (step S24). The procedure then proceeds to its end as shown in FIG. 3.

As stated above, in the illustrative embodiment, the digital camera 1 is capable of recording digital image data free from a conspicuous seam by correcting the gains of the image data by comparing the seam portions of two image areas 97 and 99, i.e. by correcting pixel data belonging to different areas and different in characteristic from each other. Because the comparison is executed only with the seam portions, accumulation and correction can be completed in a short period of time.

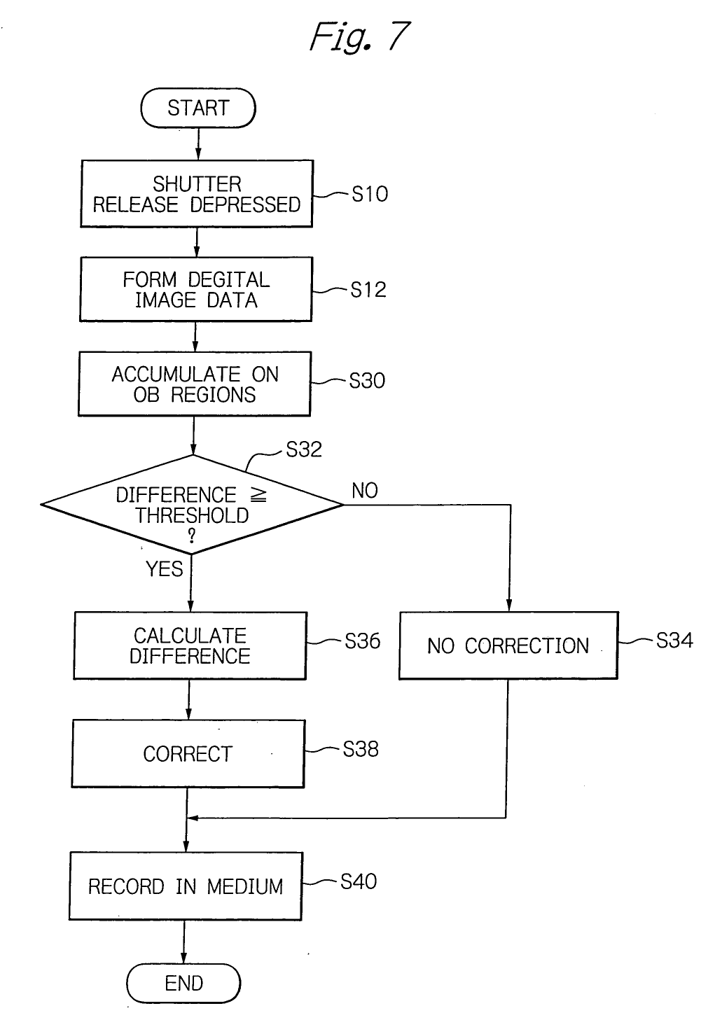

FIG. 7 is a flowchart demonstrating another specific pickup mode operation available with the illustrative embodiment and executed in response to a pickup mode command fed from the control panel 3 to the controller 3. In FIG. 7, steps like shown in FIG. 3 are designated by identical reference numerals respectively, and will not be described specifically again in order to avoid redundancy.

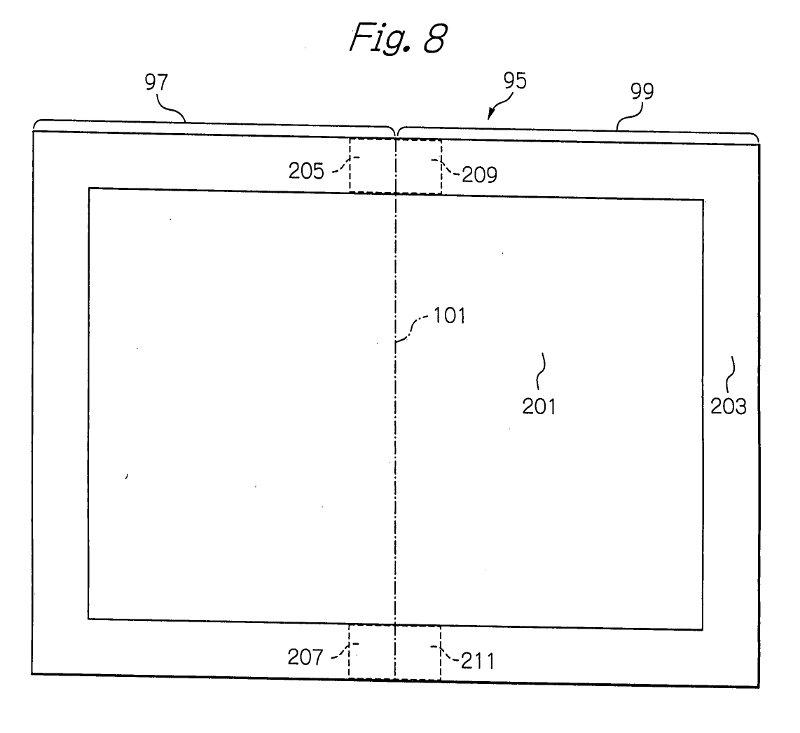

Reference will be made to FIG.8 useful for understanding another specific procedure shown in FIG. 7. In FIG. 8, constituents like those shown in FIG. 4 are designated by identical reference numerals, and will not be described specifically in order to avoid redundancy.

Briefly, in the procedure shown in FIG. 7, the accumulator 23 accumulates, among pixel data corresponding to the seam portions, pixel data corresponding to OB zones, i.e. black level sensing portions included in the image sensor 11 because the OB zone 203 is formed by optically shielding the photodiodes or photosensors of the image sensor 11, so that a difference between pixel data forming the OB zone 203 is indicative of a difference in characteristic between the output sections 63 and 65, FIG. 2, of the first and second areas 69 and 71, FIG. 2. Therefore, in the procedure shown in FIG. 7, pixel data in the OB zone 203 are accumulated to determine a difference between the output sections 63 and 65.

Further, the procedure of FIG. 7 executes correction if a difference between the integrated values or sums is great, contrary to the procedure of FIG. 3. This is because a great difference between the sums integrated in the OB zones indicates that a difference in characteristic between the output sections 63 and 65 assigned to the areas 69 and 71, respectively, is great. It is to be noted that when the characteristic of pixel data belonging to one area should be matched to the characteristic of the pixel data of the other area, all the pixel data belonging to the other area are corrected, i.e. correction is not executed on a segment basis.

As shown in FIG. 7, when the operator depress the shutter release key to then cause the pixel data 83 to be input to the accumulator (steps S10 and S12), the accumulator 23 accumulates, among the pixel data included in the digital image data 83 input thereto, pixel data adjoining the central line 101 in the OB zone in each of the image areas 97 and 99 (step S30). As stated previously with reference to FIG. 5, the pixel data at the first to fifth pixels at the left and right of the central line 101 are accumulated in OB first image area 97 and $$99 respectively.

As shown in FIG. 8, because the OB zone 203 surrounds the effective area 201, two OB regions 205, 209 and 207, 211 exist at the top and bottom of the central line 101. The accumulator 23 therefore accumulates pixel data present in the OB regions 205 through 211 in the first and second image areas 97 and 99 on a region basis. More specifically, the accumulator 23 accumulates pixel data present in a OB region 205 through 211 region by region, thereby producing four different sums. Alternatively, the accumulator 23 may accumulate the pixel data area by area. In any case, the resulting sums are fed to the system controller 5 from the accumulator 23 over the data bus 39.

As shown in FIG. 7, the system controller 5 then calculates a difference between each neighboring OB regions, between the OB region 205 and the OB region 209 and between the OB region 207 and the OB region 211, in order to determines whether or not the difference is greater than a predetermined value inclusive, i.e. whether or not correction is necessary (step S32). The predetermined value may be the same value as used in procedure shown in FIG. 3 or may be another one.

If the difference is smaller than the predetermined value (No, step S32), then the system controller 5 determines that the correction is not necessary (step S34). In this case, the system controller 5 has the signal processor 25 forming the digital image data 89 from the non-corrected data 83 in order to in order to have the monitor 27 displaying non-corrected image and the medium 31 recording the non-corrected image data (step S40). The procedure then proceeds to its end as shown in FIG. 7. Conversely, if the above difference is greater than the predetermined value inclusive (Yes, step S32), then the system controller 5 determines that correction is necessary, and then calculates a difference in characteristic between the pixel data lying in the area 69 and the pixel data lying in the area 71 in order to produce correction value (step S36). Alternatively, the system controller 5 may read out correction value from the storage, not shown, with the calculated difference and/or accumulated sums.

Subsequently, in order to make up for the difference between the image area 97 and 99 for producing a smooth image, the system controller 5 has the signal processor 25 correcting the pixel data via control signal 41 (step S38). In response, in the illustrative embodiment, the signal processor 25 corrects the difference by matching the tint or the luminance of the pixel data lying in the first image area 97 to the tint or the luminance of the pixel data lying in the second image area 99. Of course, such a correcting method is only illustrative and may be changed or modified, as desired.

Further, the signal processor 25 formats the corrected digital image data to the data 87 and 91. The monitor uses the data 87 in order to display the corrected image and the recording medium 31 records the data 91 under the control of the medium controller 29 (step S40). The procedure then proceeds to its end as shown in FIG. 7.

As stated above, in the procedure shown in FIG. 7, the digital camera 1 corrects image data by comparing the OB regions adjoining the central line or seam of the image to thereby record digital image data free from conspicuous seam. The digital image data thus recorded can form a smooth image free from a conspicuous seam because pixel data different in characteristic are corrected on an OB region basis.

Modifications of the procedure shown in FIG. 3 or 7 will be described hereinafter. Either one of the pickup mode operations shown in FIGS. 3 and 7 may be selected, as desired. For example, the pickup mode operations of FIGS. 3 and 7 may be programmed in the digital camera 1, so that either one of them can be selected on the control panel 3. Further, the pickup mode operations of FIGS. 3 and 7 may be combined such that both the comparison based on the segment and the comparison based on the OB region may be executed in order to correct pixel data in accordance with the results of comparison, and such a procedure may also be programmed in the digital camera 1.

The digital camera 1 does not have to be driven in the pickup mode of FIG. 3 or 7, including integration and correction, in all pickup modes available with the digital camera 1, but may be selectively driven in the pickup mode of FIG. 3 or 7 on the basis of shutter speed, pickup sensitivity or temperature at the time of pickup. For example, lightness is generally dependent on shutter speed and the exposure of optics. Therefore, when shutter speed is lower than a predetermined value, it is likely that the resulting digital image data are light and make the difference between the pixel data of nearby areas conspicuous. In this respect, the pickup mode of FIG. 3 or 7, capable of producing a smooth image free from conspicuous seam, is desirable.

Also, when the operator desires to increase the gain for generating attractive image data even when pickup sensitivity is higher than usual, e.g., when the amount of analog signal charges generated in the image sensor 11 is small, the difference of pixel data of nearby areas is apt to be conspicuous. In this respect, too, the pickup mode of FIG. 3 or 7, capable of producing a smooth image free from a conspicuous seam, is desirable.

Further, when the digital camera 1 is driven in a high-temperature environment, it is likely that the amplification ratios of the output sections 63 and 65 vary each and also render the difference of pixel data of nearby areas conspicuous. When temperature around the camera 1 is higher than, e.g., 35° C., the pickup mode of FIG. 3 or 7 is effective to solve such a problem.

Whether or not to drive the digital camera 1 in the pickup mode of FIG. 3 or 7, including integration and correction, in dependence on shutter speed, sensitivity selected or surrounding temperature may be determined by the system controller 5. For example, when the system controller 5 is configured to determine that shutter speed is lower than predetermined one on the basis of the operation signal 33 or that pickup sensitivity is higher than usual, it may control the various sections of the camera 1 in such a manner as to feed the digital image data 83 to the accumulator 23 for obtaining sums to thereby execute the sequence of FIG. 3 or 7.

Surrounding temperature may be sensed by, e.g., a thermometer or a temperature sensor, not shown, mounted on the digital camera 1. When the output of the thermometer or that of the temperature sensor shows that surrounding temperature is higher than predetermined one, the system controller 5 may so control the various sections of the camera 1 in such a manner as to feed the digital image data 83 to the accumulator 23 and obtain sums to thereby execute the procedure of FIG. 3 or 7. In short, the camera 1 may be driven in the pickup mode of FIG. 3 or 7 whenever the difference between the pixel data, belonging to nearby areas, is apt to become conspicuous.

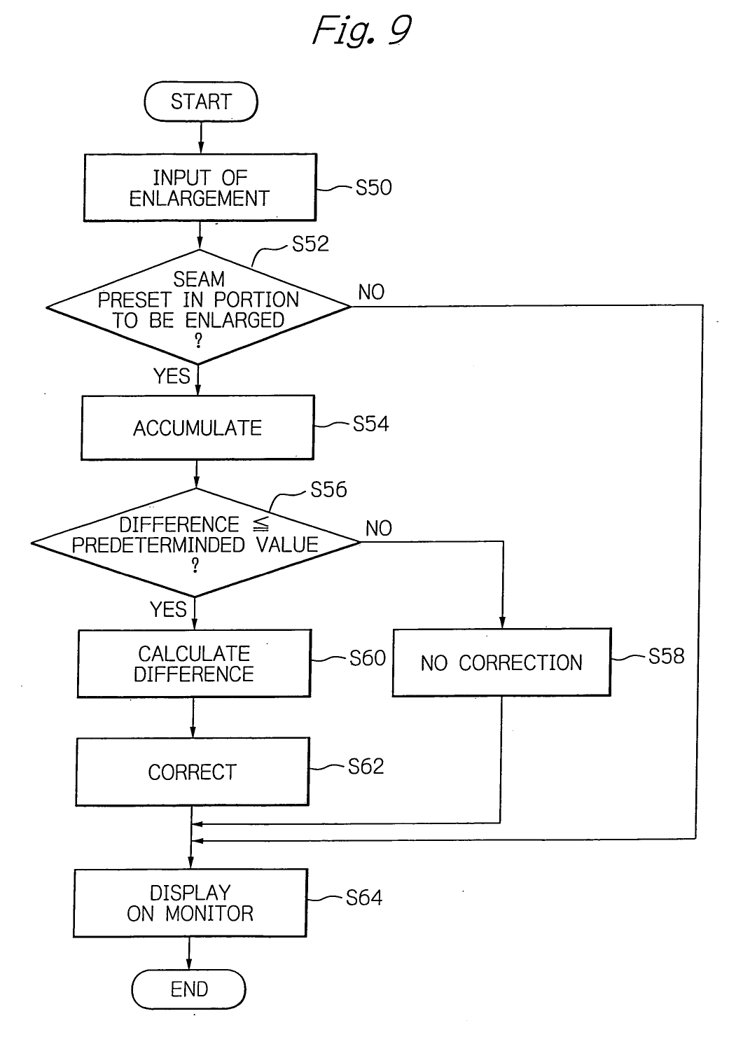

FIG. 9 demonstrates a specific procedure also available with the illustrative embodiment and executed when the drive signal 33 fed from the control panel 3 to the system controller 5 is indicative of a mode for enlarging the digital image data.

As shown in FIG. 9, the drive signal 33 indicative of the enlargement of the image, i.e. having the camera outputting the enlarged part of an image to the monitor 27, is input from the control panel 3 to the system controller 5 (step S50). It is to be noted that the image to be enlarged may be either one of images stored or to be stored, as digital image data, in the recording medium 31. In response to the drive signal 33, the system controller 5 determines whether or not the seam is included in the part of the digital image data which outputs as enlarged image to the monitor.27 (step S52). If the answer of the step S42 is No, the digital image data are output as simply enlarged image to the monitor 27 (No, step S52), the procedure proceeds to its end as shown in FIG. 9.

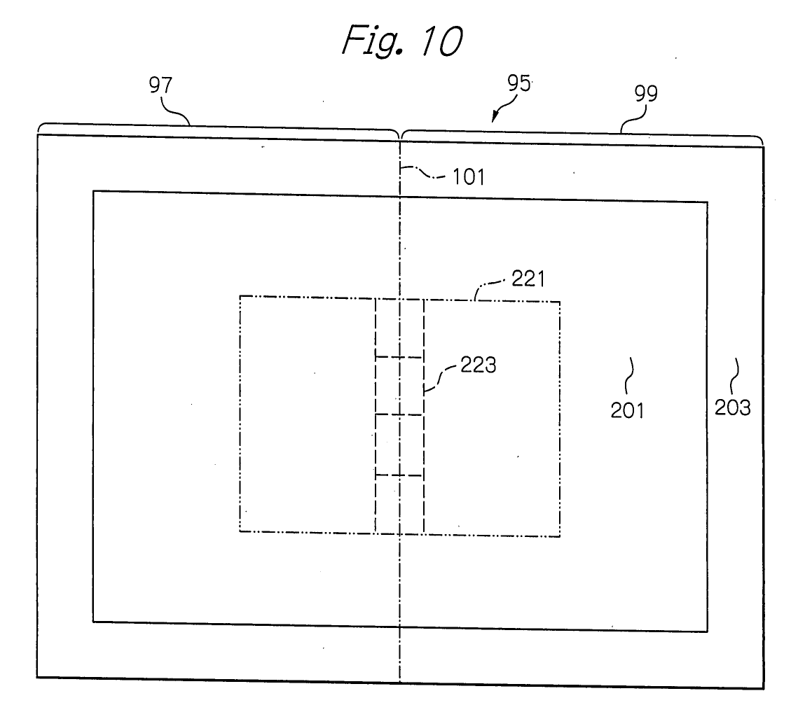

On the other hand, if the answer of the step S52 is Yes, meaning that the seam is included in the desired part of the image, as shown in FIG. 10, the system controller 5 commands the accumulator 23 to accumulate the pixel data forming the seam portion of digital image data. In response, the accumulator 23 accumulates the above part in the image (step S54). FIG. 10 shows the image 95 formed by the digital image data; portions like those shown in FIG. 3 are designated by identical reference numerals and will not be described specifically. As shown, assume that the operator desires to enlarge substantially the center portion of the image 95 that includes the central line or seam 11 of the image 95, as indicated by a dash-and-dot line 221 in FIG. 10. Then, the accumulator 23 equally divides the seam portion 223 of the center portion 221 into four segments and then accumulates the first to fifth pixel data, as counted from the seam 101 in the horizontal direction, segment by segment, as stated previously with reference to FIG. 5.

Subsequently, the accumulator 23 feeds sums thus produced segment by segment to the system controller 5 over the data bus 39. The system controller 5 produces a difference between each nearby segments and then determines whether or not correction is necessary (step S56). In the specific procedure shown in FIG. 9, because image data in the effective areas are integrated, the difference, if great, shows that the seam portion is not conspicuous as in an image in which color changes in the image portion and therefore does not have to be corrected. Conversely, the difference, if small, shows that the seam portion is conspicuous and must therefore be corrected. The system controller 5 therefore determines that segments with a difference greater than a predetermined value (No, step S56) do not need correction (step S58), and commands the signal processor 25 to directly output the digital image data without correction (step S64), the procedure proceeds to its end as shown in FIG. 9.

On the other hand, if the difference between the nearby segments is small (Yes, step S56), the system controller 5 calculates, e.g., a gain difference or a luminance difference (step S60) and then commands the signal processor 25 to correct the pixel data in accordance with the difference calculated. In response, the signal processor 25 corrects the pixel data (step S62). In the illustrative embodiment, the signal processor 25 is configured to correct the gain of the pixel data. Subsequently, the signal processor 25 processes the digital image data corrected to be displayed on the monitor 27 and then outputs enlarged image to the monitor 27 (step S64), the procedure proceeds to its end as shown in FIG. 9.

As stated above, with the procedure shown in FIG. 9, it is possible to produce a smooth image free from a conspicuous seam even when the image is enlarged.

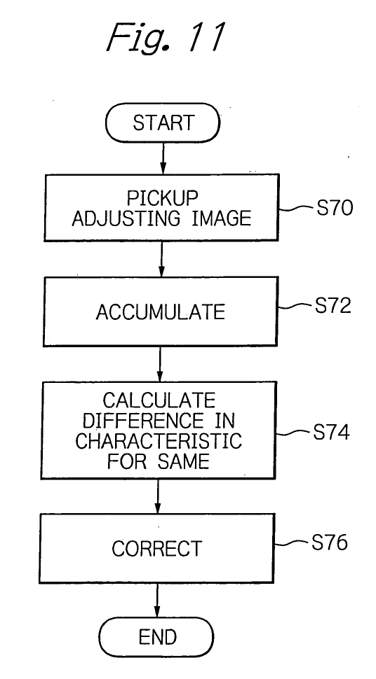

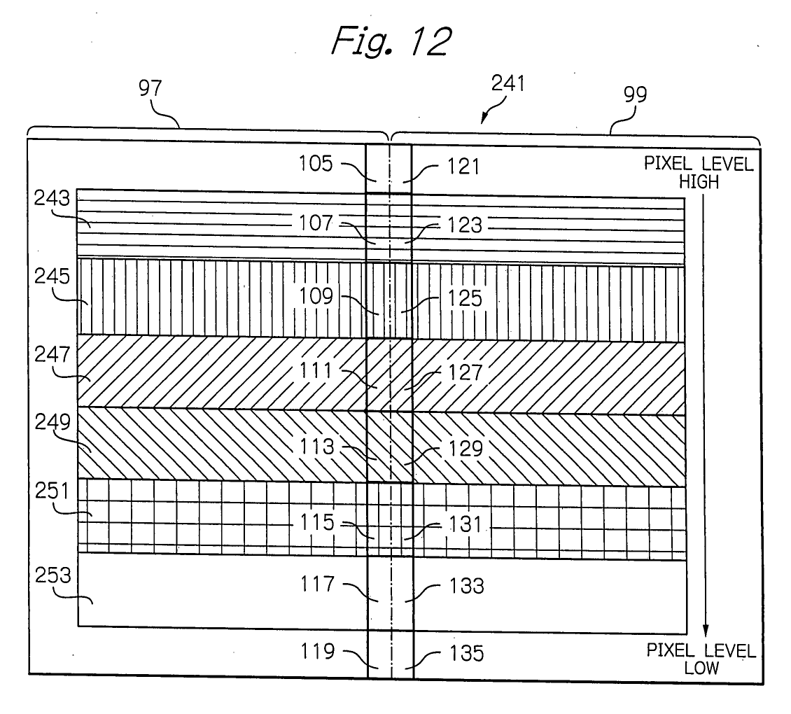

FIG. 11 shows another specific correction procedure available with the illustrative embodiment and applicable to the image 95 of FIG. 4. FIG. 12 shows a specific image 241 produced by the digital camera 1 in the procedure shown in FIG. 11. In FIG. 12, portions like those shown in FIG. 4 are designated by identical reference numerals, and will not be described specifically in order to avoid redundancy.

Briefly, in the procedure shown in FIG. 11, the digital camera 1 produces an image 241 as shown in FIG. 12, i.e. the digital camera 1 picks up a field like an image 241 such that the segments are different in level, i.e. color, whereas adjoining segment between the areas 69 and 71 are identical. Because, in the illustrative embodiment, the seam portion are divided into the segments in the vertical direction, it is possible to grasp a difference in linearity between the image areas, i.e. a difference in pixel level between the image data of the same color, by producing the image 241 and accumulating the pixel data of the image 241 segment by segment.

More specifically, as shown in FIG. 11, the camera 1 picks up the field image like shown in FIG. 12 and produce the image 241 in, e.g. a setting step preceding actual pickup (step S70). The image 241 is equally divided into six zones 243, 245, 247, 249, 251 and 253 in the vertical direction, as counted from the top toward the bottom. The zones 243 through 253 are formed by pixel data produced from the same field image, i.e. from the same color in both the image areas 97 and 99 each; the pixel level of the pixel data sequentially decreases stepwise from the zone 243 to the zone 253.

Further, as understood from FIG. 12, each of the segments 107 through 117 and 123 through 133 are provided with a length, as measured in the vertical direction, corresponding to the length of each of the zones 243 through 253 to be individually integrated by the accumulator 23. Therefore, if the image areas 97 and 99 have identical characteristic, then the sum produced from the 1B segment 107 and the sum produced from the 2B segment 123 are equal to each other, for example.

As shown in FIG. 11, the image data of the image 241 is feed to the accumulator and accumulator 23 then accumulates the pixel data of each of the segments 107 through 117 and 123 through 133 corresponding to each other and outputs the resulting sums (step S72). The sums are fed from the accumulator 23 to the system controller 5. In response, the system controller 5 calculates a difference between the image areas 97 and 99 for the same color, i.e. a difference in linearity between the output sections 63 and 65 of the image sensor 11 (step S74). The system controller 5 then controls the gain to be multiplied by, e.g., the signal processor 25 or the preprocessor 17 such that image data of the same pixel level for the same color are formed (step S76). Alternatively, the system controller 5 may control, e.g., the offset voltage of amplifiers included in the output sections 63 and 65 such that the outputs of the output sections 63 and 65 are identical with each other.

As stated above, with the procedure of FIG. 11 using image data for adjusting difference in linearity, it is possible to correct a difference between the pixel levels of pixel data of the same color lying in the different image areas 97 and 99, thereby outputting digital image data free from a conspicuous seam.

In summary, the present invention provides a digital camera which produces a difference between adjoining areas from pixel data corresponding to a seam portion between the areas and corrects the pixel data in accordance with the difference for thereby forming image data free from a conspicuous seam without resorting to any extra device. Therefore, the digital camera of the present invention is low cost and prevents a solid-state image sensor included therein from being increased in size.

The entire disclosure of Japanese patent application No. 2005-286905 filed on Sep. 30, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A digital camera comprising:
a solid-state image sensor including an image sensing surface divided into a plurality of areas for producing a plurality of analog electric signal streams representative of a corresponding plurality of divided images on a basis of the plurality of divided areas;
an analog signal processor for executing analog signal processing on the plurality of analog electric signal streams and converting resulting processed analog electric signals to a corresponding plurality of digital image signals;
a digital signal processor for executing digital signal processing on each of the plurality of digital image signals to thereby produce a single frame of image;
an accumulator configured to accumulate pixel data that forms a seam between the plurality of divided images in the single frame of image;
a calculator configured to calculate the difference in characteristic between the plurality of divided images on the basis of sums output from said accumulator; and
a corrector configured to correct the pixel data in accordance with the difference output from said calculator.

2. The digital camera in accordance with claim 1, wherein said digital camera determines whether or not to execute correction in accordance with a shutter speed.

3. The digital camera in accordance with claim 1, wherein said digital camera determines whether or not to execute correction in accordance with ISO (International Standards Organization) sensitivity.

4. The digital camera in accordance with claim 1, wherein said digital camera determines whether or not to execute correction in accordance with temperature around said digital camera.

5. The digital camera in accordance with claim 1, wherein said corrector corrects other pixel data as well as the pixel data used in accumulating.

6. The digital camera in accordance with claim 1, wherein said accumulator accumulates, area by area, the pixel data in an effective area;
said calculator calculates a difference between the sums output from said accumulator;
said corrector corrects the pixel data if the difference is smaller than a predetermined value.

7. The digital camera in accordance with claim 1, wherein said accumulator accumulates, area by area, the pixel data corresponding to an optical black area included in the portion forming the seam;
said calculator calculates a difference between the sums output from said accumulator;
said corrector corrects the pixel data in an effective area if the difference is larger than a predetermined value.

8. The digital camera in accordance with claim 1, wherein when part of the image should be enlarged and if the portion forming the seam is included in said part of the image, said accumulator integrates, area by area, the pixel data corresponding to the portion forming the seam included in said part of said image.

9. The digital camera in accordance with claim 1, wherein said accumulator divides the portion forming the seam into a plurality of segments in each of the plurality of areas and accumulates the pixel data lying in the segments that corresponds to each other.

10. The digital camera in accordance with claim 9, wherein said corrector corrects the pixel data on a segment basis.

11. The digital camera in accordance with claim 9, wherein segments are variable in their size depending on a field to be picked up.

12. The digital camera in accordance with claim 9, wherein the pixel data is different in level segment by segment; and
said accumulator accumulates the pixel data segment by segment in order to grasp a difference in linearity between the plurality of divided images.
